(19) United States
(12) Patent Application Publication
(10) Pub. No.: US 2006/0101164 A1
(43) Pub. Date: May 11, 2006

(54) Context switch architecture and system

(75) Inventors: Sherman Lee, Rancho Palos Verdes, CA (US); Vivian Y. Chou, Alhambra, CA (US); John H. Lin, Downey, CA (US)

Correspondence Address: CHRISTIE, PARKER & HALE, LLP, PO BOX 7068, PASADENA, CA, 91109-7068, US

(73) Assignee: Broadcom Corporation

(21) Appl. No.: 11/314,036

(22) Filed: Dec. 20, 2005

Related U.S. Application Data
(63) Continuation of application No. 09/592,009, filed on Jun. 12, 2000.

(51) Int. Cl. G06F 3/00

(52) U.S. Cl. 710/19; 710/15; 712/228; 370/310; 710/8

(57) ABSTRACT

A method and system for performing switch operations utilize non-architectural registers to store context information. Data in a first context register on a peripheral system is accessed (e.g., read or write) until a host computer provides a new index value to an index register on the peripheral system. A context switch occurs, and the context register associated with the new index value is accessed. In some embodiments a system that performs context switching includes a host computer, at least one peripheral system coupled to the host computer, an interface between the host computer and the peripheral system, and a register access circuit coupled to the host computer. The register access circuit is configured to access data in a first or a second register on the peripheral system if the first or a second index value, respectively, is provided by the host computer.

### CROSS-REFERENCE TO RELATED APPLICATION(S)

This application is a continuation of U.S. patent application Ser. No. 09/592,009, filed Jun. 12, 2000, the disclosure of which is hereby incorporated by reference herein.

### COPYRIGHT NOTICE

Portions of this patent application contain materials that are subject to copyright protection. The copyright owner has no objection to the facsimile reproduction by anyone of the patent document, or the patent disclosure, as it appears in the Patent and Trademark Office file or records, but otherwise reserves all copyright rights whatsoever.

### BACKGROUND

1. Field of the Invention

This invention relates to computing systems and, more particularly, to an architecture and system for switching contexts, where the context switching is accelerated through the use of hardware registers to store context data.

2. Description of Related Art

The Bluetooth Specification is an open technical specification and a de facto standard for a wireless (radio) communication technology. The Bluetooth technology is a short-range low-power radio link for transmission of digital data and analog voice data. Bluetooth allows the replacement of the numerous and varied proprietary cables that connect one computer or communication device to another with one universal short-range radio link. Users can therefore connect a wide range of computing and telecommunications devices without the need to buy, carry, or connect cables. For example, a computer can communicate with a printer via a radio link instead of a cable. Bluetooth also allows computing devices to connect to a communicating device via a radio link. For example, a computer can communicate with a cell phone via a radio link to access the Internet.

Bluetooth systems connect to each other in piconets, which are formed by a master system connecting with at least one other system sharing the same channel. Most Bluetooth systems can act as either a master or a slave; the terms “master” and “slave” merely refer to the roles played by each device within a particular piconet. One Bluetooth system acts as the master of the piconet. In addition to the master, a piconet may include an additional number of Bluetooth systems that act as slaves. For more details, please refer to “Specification of the Bluetooth System-Core v1.0b” available from the Bluetooth Special Interest Group at its web site. Part B, “Baseband Specification”, of Vol. I (“Core”) ver. 1.0b of the Bluetooth Specification is herein incorporated by reference in its entirety for all purposes.

Each master of a Bluetooth piconet can switch contexts from one slave to another. In addition, because a slave can participate in more than one piconet, a slave can switch contexts among masters. Traditional approaches render the context-switch process slow and cumbersome. What is needed is a system and method for performing relatively rapid context switches while still retaining an acceptable level of network throughput.

### SUMMARY

A method of performing a context switch operation involves accessing context data in a first register of a peripheral system, where the first register is associated with a first index register. The method further includes receiving a second index value from a host computer associated with the peripheral system. The host computer's providing of the second index value when the peripheral system had been accessing the first register causes a context switch from the first register to the second register. Accordingly, the method further includes accessing context data in a second register of the peripheral system, where the second register is associated with the second index value. In at least one embodiment of the method, the first and second registers are not architected registers.

In at least one embodiment, accessing the context data in the second register further comprises performing a write function to an identified address within the second register. In at least one other embodiment, accessing the context data in the second register further comprises providing the contents of an identified address within the second register to the host computer. In at least one other embodiment, accessing the context data in the second register further comprises performing a read operation, depending on the value of a control input. In at least one other embodiment, accessing the context data in the second register further comprises performing a write operation, depending on the value of a control input.

At least one embodiment of a system comprises a host computer that includes a microprocessor, at least one peripheral system coupled to the host computer, an interface between the host computer and the peripheral system, and a register access circuit coupled to the peripheral system. The peripheral system includes a first register that is associated with a first index value and also includes a second register that is associated with a second index value. The interface is configured to provide the first and second index values from the host computer to the peripheral system. The register access circuit is configured to access data in the first register if the first index value is provided by the host computer and is further configured to access data in the second register if the second index value is provided by the host computer. In at least one embodiment of the system, the first and second registers are not architected registers.

At least embodiment of the peripheral system further includes a state machine, where the state machine includes an address portion, a control portion, and a data portion, where the first and second registers are included in the data portion. At least one embodiment of the address portion includes a register access circuit. At least one other embodiment of the peripheral system further includes a microprocessor. At least one other embodiment of the peripheral system includes at least one index register. At least one other embodiment of the peripheral system includes a plurality of context registers, with each of the plurality of context registers being associated with one of a plurality of index values.

### BRIEF DESCRIPTION OF THE DRAWINGS

FIG. 1 illustrates, in a block diagram, a point-to-point network between two computing devices.

FIG. 2 illustrates, in a block diagram, a point-to-multipoint network among a plurality of computing devices.

FIG. 3 is a block diagram illustrating a scatternet that includes multiple piconets with overlapping coverage.

FIG. 4 is a block diagram illustrating a register architecture for maintaining master and slave context information in a peripheral device.

FIG. 5 is a block diagram illustrating at least one embodiment of the format of a slave index and slave register.

FIG. 6 is a block diagram illustrating at least one embodiment of the format- of a master index and master register.

FIG. 7 is a data flow diagram illustrating at least one embodiment of the data flow during the use of a master index to perform context-switching for a slave device.

FIG. 8 illustrates a data flow diagram illustrating at least one embodiment of the data flow during the use of a slave index to perform context-switching for a master device.

FIG. 9 illustrates at least one embodiment of a system embodying the context-switch architecture of the present invention.

FIG. 10, including FIG. 10a and FIG. 10b, is a state transition diagram illustrating a state machine according to one embodiment of the present invention.

FIG. 11 is a flowchart illustrating at least one embodiment of a master parameter access module.

FIG. 12 is a flowchart illustrating at least one embodiment of a slave parameter access module.

### DETAILED DESCRIPTION

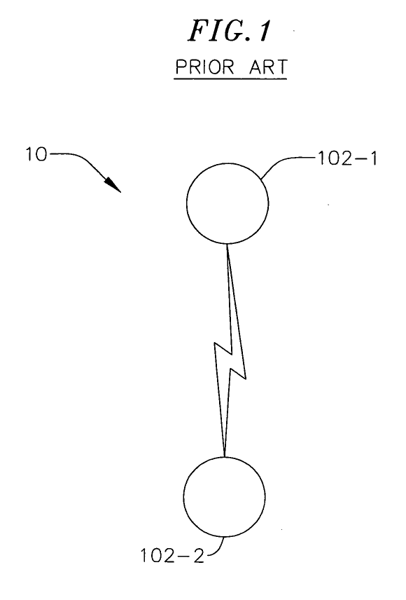

FIG. 1 illustrates a network 10 that includes two computing devices 102-1,102-2. Network 10 is, for example, a wireless Bluetooth point-to-point piconet where wireless device 102-1 is a master Bluetooth system and wireless device 102-2 is a slave Bluetooth system, where the master 102-1 and slave 102-2 share the same channel. One skilled in the art will recognize that a point-to-point network need not include Bluetooth devices 102-1, 102-2, but, rather, may comprise any type of computing device.

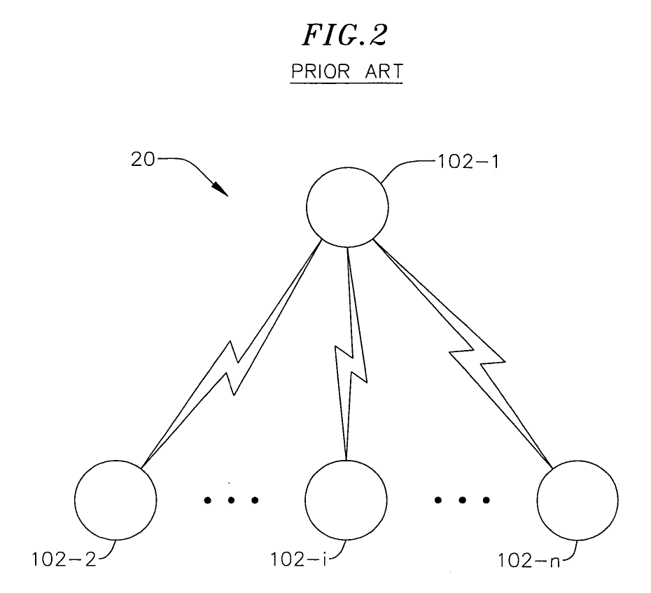

FIG. 2 illustrates a network 20 that includes a plurality of wireless devices 102-1, 102-2 . . . 102-i . . . 102-n (2≦i≦n). Wireless network 20 is, for example, a point-to-multipoint Bluetooth piconet where wireless device 102-1 is a master Bluetooth system and wireless devices 102-2 through 102-n are slave Bluetooth systems. As with all piconets, the master 102-1 and all the slaves 102-2 through 102-n communicate over the same channel. In at least one embodiment, up to seven slaves can be active in the piconet 102. One skilled in the art will recognize that the number of active slaves supported in a piconet depends on many variables and design considerations. Any of number of slaves can be supported. One skilled in the art will further recognize that a point-to-point network need not include Bluetooth devices 102-1, 102-2, but, rather, may comprise any type of computing device.

In addition to the active slaves 102-2, 102-i through 102-n illustrated in FIG. 2, a point-to-multipoint piconet 20 may include many additional slaves that can remain locked to the master 102-1 in a so-called “parked” state. When a slave does not need to participate on the piconet channel, but still needs to remain synchronized to the channel it can enter the low-power parked state. These parked slaves cannot be active on the piconet channel, but remain synchronized to the master. In at least one embodiment, up to 256 parked slaves may remain locked to the master. For additional information regarding an implementation of the synchronization of master and slave Bluetooth systems, please refer to commonly assigned U.S. Pat. No. 6,650,880, which is herein incorporated by reference for all purposes.

For both active and parked slaves in a single piconet 10, 20, the master 102-1 controls the channel access. This results in a need for the master 102-1 to switch control from one slave to another as it controls channel access within the piconet. The master 102-1 identifies each slave through a unique network address assigned to each slave. When a transfer of information between two slaves in a piconet 10, 20 is desired, the master 102-1 coordinates transmission between two slaves.

Referring to FIG. 2, for instance, slave 102-2 could be a wireless personal digital assistant (“PDA”) device equipped with a Bluetooth system and slave 102-i could be a wireless cellular telephone equipped with a Bluetooth system. In such case, the master 102-1 can coordinate communications between the two slaves 102-2, 102-i over the piconet channel to exchange, for instance, phone number information. To do so, the master 102-1 must switch focus between the first slave 102-2, commanding it to transmit phone number data to the master 102-1, and the second slave 102-i, commanding it to receive phone number data from the master 102-1. This switch in focus, referred to herein as a “context switch” requires the master to be able to store and access context information regarding each slave in relatively rapid succession.

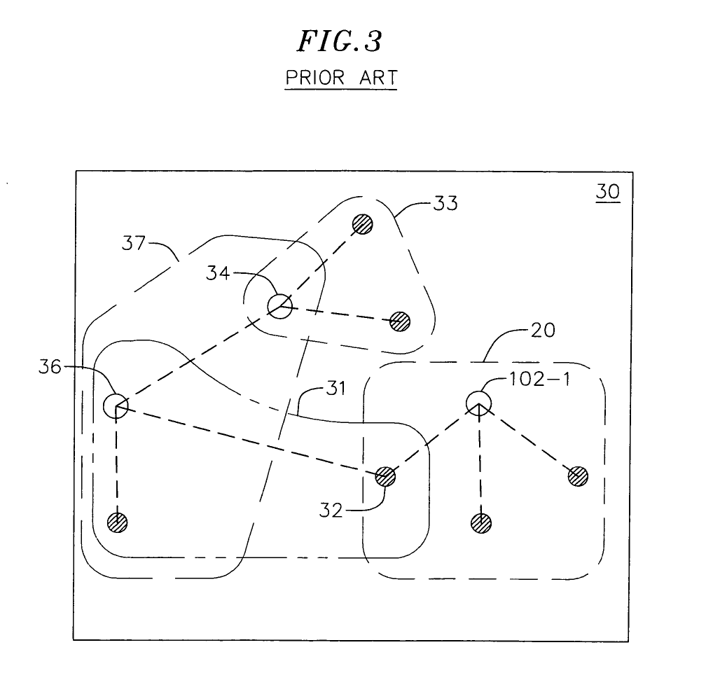

FIG. 3 illustrates that context-switching ability is also required for slaves that participate in more than one piconet. FIG. 3, illustrates, for instance, a “scatternet” 30, formed from multiple networks with overlapping coverage. A Bluetooth piconet 31, 33, 20 (FIG. 2) can form part of a larger Bluetooth scatternet 30. Each piconet 31, 33, 20 (FIG. 2) can only have a single master 36, 34 and 102-1, respectively. However, FIG. 3 illustrates that slaves can participate in multiple piconets on a time-division multiplex basis. For instance, in FIG. 3 slave 32 participates in two piconets: piconet 20 having master 102-1 and piconet 31 having master 36. In addition, a master 34 in one piconet 33 can be a slave in another piconet 37.

The discussion above illustrates the need, in a network environment such as, for instance, a wireless network as specified in the Bluetooth Specification, for both masters and slaves to have the ability to quickly switch contexts in order to facilitate orderly, reasonably rapid communication among wireless devices. In a different context, several schemes exist for switching contents among software application programs. These schemes usually involve storing context information in memory and then, during a context switch, loading the information from memory into a particular register or set of registers. Such software-based context-switching schemes are disclosed, for example, in U.S. Pat. No. 6,061,711, entitled “Efficient Context Saving and Restoring in a Multi-Tasking Computing System Environment”, and issued to Song et al. and also in U.S. Pat. No. 5,812,823, entitled “Method and System for Performing an Emulation Context Save and Restore that is Transparent to the Operating System”, and issued to Kahle et al. Song '711 and Kahle '823 are hereby incorporated by reference for all purposes.

In a software-based context-switching scheme, a set of hardware registers is used to contain current context information. When a context switch occurs, the information in the registers for outgoing context is stored from the registers to a memory location, such as a location in main memory or in a cache. The context information for the incoming context is then loaded from a different memory location into the registers. This storing to, and loading from, memory to transfer, via software, data between memory and hardware registers is time-consuming and processor-intensive. To employ such an approach for switching contexts among masters and slaves in a network of computing devices, such as a network of Bluetooth systems, would result in severely limited network throughput during the context-switch process.

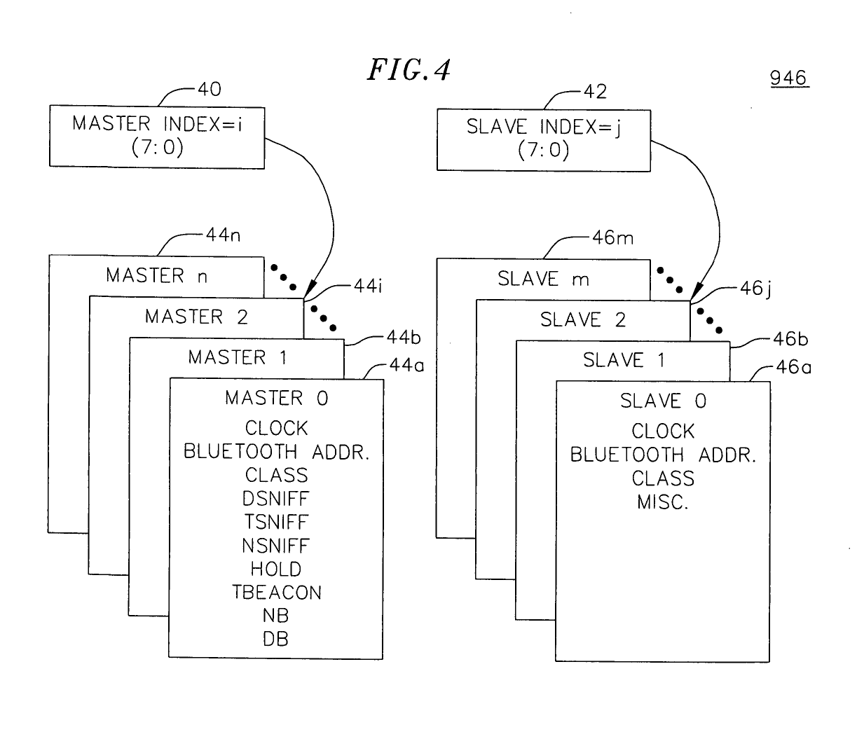

FIG. 4 is a generalized block diagram illustrating a context-switching register architecture according to at least one embodiment of the present invention. A preliminary discussion of general register architectures is appropriate before discussing the particular aspects of the register architecture of the present invention. Computer systems, such as the host computer 970 illustrated in FIG. 9, typically have a relatively large, relatively slow main memory. Typically, multiple dynamic random access memory (DRAM) modules comprise the main memory system. The time that it takes to transfer a set of bytes of information from the main memory to the microprocessor (“access time”) of modem DRAMs is longer than the clock cycle length of modem microprocessors.

In order to provide a faster means for the microprocessor to access stored information, a set of registers is usually provided within the microprocessor. As used herein, a register is a storage location provided within the microprocessor or a peripheral device, where the storage location may be identified by an instruction as storing an operand. In other words, a register is “programmer visible”; the programmer may code an instruction that has the register as an operand identifier. Since registers are included within the microprocessor or peripheral, and because the register address is coded directly into an instruction, registers can be accessed rapidly.

FIG. 4 illustrates that the architecture scheme in accordance with at least one embodiment of the present invention includes a plurality of hardware registers 40, 42, 44a-44n, 46a-46m that maintain context information. In at least one embodiment, the hardware registers 40, 42, 44a-44n, 46a-46m are provided in a peripheral system 972 (FIG. 9) rather than in the microprocessor of a host computer 970 (FIG. 9). In at least one embodiment, n=8 and m=8, such that eight master registers 44a-44n and eight slave registers 46a-46m are provided. In at least one other embodiment, which is illustrated in FIG. 4, four master registers 44a-44n and four slave registers 46a-46n are provided. The architecture illustrated in FIG. 4 also includes a master index 40 and a slave index register 42. Because many devices can act as either masters or slaves, at least one embodiment of the present invention includes master registers 44a-44n and master index register 40, as well as slave registers 46a-46m and slave index register 42 in every network device operating in a master/slave environment. One skilled in the art will recognize that at least one embodiment of the present invention need only include the slave registers 46a-46m and the slave index register 42, but not the master registers 44a-44n or the master index register 40, in devices that only act as masters. Similarly, at least one embodiment of the present invention need include only the master registers 44a-44n and the master index register 40, but not the slave registers 46a-46m or the slave index register 42, in devices that only act as slaves.

One skilled in the art will further recognize that numerous design considerations affect the number, size and organization of the master registers 44a-44n and slave registers 46a-46m. The present architecture is therefore scalable to accommodate any number of master registers 44a-44n and slave registers 46a-46m. For instance, while a computing device acting as a master can maintain four slave registers 46a-46m, the number of slave registers 46a-46m is, of course, scalable. For example, because a master 102-1 (FIG. 1), 36 (FIG. 3) can control up to seven slaves 102-2-102-n according to ver. 1.0b of the Bluetooth Specification, at least one embodiment of the present invention includes seven slave registers 46a-46m in each Bluetooth system 102-1 (FIG. 1), 36 (FIG. 3) that is capable of acting as a master. In at least one other embodiment, a Bluetooth master system 102-1 (FIG. 1), 36 (FIG. 3) includes 256 slave registers 46a-46m in order to maintain context information for 256 parked slaves.

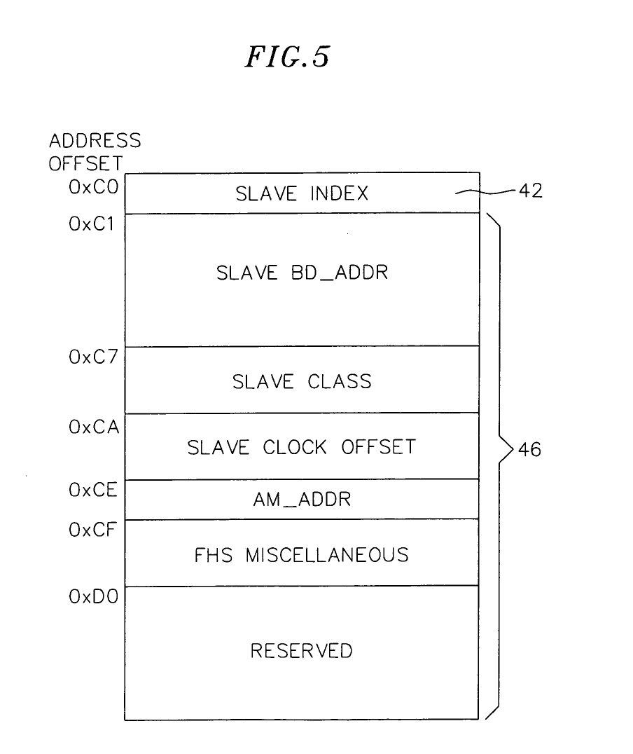

FIG. 5 and Table 1 set forth an exemplary format of the information stored in each slave register 46. One skilled in the art will recognize that the format of the slave registers 46 will depend on specific design considerations. In general, the slave registers 46 contain any context information and parameters necessary to allow the master system 102-1 (FIG. 1), 36 (FIG. 3) to quickly switch contexts among slave systems. The format and the addresses of the information set forth in FIG. 5 and Table 1 should be taken to be an exemplary format and address scheme only. One skilled in the art will recognize that the fields may be stored in any order, at any register location.

TABLE 1

| | | | readable/ | bit | connection | | # of | |
|---|---|---|---|---|---|---|---|---|
| address | name | reset | writable | location | field | description | bits | default |
| 0xC1 | NAP_hi | s | R/W | [7:0] | NAP[15:8] | 0xc1 | 8 | x00 |
| | NAP-lo | s | R/W | [7:0] | NAP [7:0] | 0xc2 | 8 | x00 |
| | UAP | s | R/W | [7:0] | UAP[7:0] | 0xc3 | 8 | x00 |
| | LAP_hi | s | R/W | [7:0] | LAP[23:16] | 0xc4 | 8 | x00 |
| | LAP_md | s | R/W | [7:0] | LAP[15:8] | 0xc5 | 8 | x00 |
| | LAP_lo | s | R/W | [7:0] | LAP[7:0] | 0xc6 | 8 | x00 |
| 0xC7 | Class_hi | s | R/W | [7:0] | class[23:16] | 0xc7 | 8 | x00 |
| | Class_md | s | R/W | [7:0] | class[15:8] | 0xc8 | 8 | x00 |
| | Class_lo | s | R/W | [7:0] | class[7:0] | 0xc9 | 8 | x00 |
| 0xCA | clock offset | s | R/W | [7:0] | clock[27:24] | 0xca | 8 | x00 |
| | upper | | | | | | | |
| | clock offset | s | R/W | [7:0] | clock[23:16] | 0xcb | 8 | x00 |
| | hi | | | | | | | |
| | clock offset | s | R/W | [7:0] | clock[15:8] | 0xcc | 8 | x00 |
| | md | | | | | | | |
| | clock offset | s | R/W | [7:6] | clock[7:0] | 0xcd | 2 | 0 |
| | lo | | | | | | | |
| 0xCE | AM_ADDR | s | R/W | [2:0] | AM_ADDR | 0xce | 3 | 0 |
| 0xCF | FHS_misc | s | R/W | [7:6] | Scan | 0xcf | 2 | 0 |
| | | | | | Repetition | | | |
| | | s | R/W | [5:4] | Scan Period | | 2 | 0 |
| | | s | R/W | [3:1] | Page Scan | | 3 | 0 |
| | | | | | Mode | | | |

The NAP (Non-significant Address Part), UAP (Upper Address Part), and LAP (Lower Address Part) fields reflected in Table 1 together comprise the Bluetooth device network address (sometimes referred to herein as the “BD address”) for the slave system being tracked in the particular register 46. The BD address is, in at least one embodiment, 48 bits long.

The class fields (Class_hi, Class_md, Class_lo) reflected in Table 1 refer to the particular class of Bluetooth slave system being tracked in the particular register 46. For instance, PC computers, cellular phones, and personal digital assistants represent different classes of Bluetooth slave devices.

The master clock offset fields (clock offset upper, clock offset hi, clock offset md, clock offset lo) reflected in Table 1 represent a delta value between the master's clock and the slave's clock that the slave system maintains in order to synchronize its communications with the master system. This synchronization is required for the hopping scheme provided for in the Bluetooth Specification. The hopping scheme provides that the channel on which the Bluetooth systems in a piconet operate is represented by a pseudo-random hopping sequence through the available channels in the 2.4 GHz ISM band. The hopping sequence is unique for a piconet and is determined by the BD address of the master. The phase in the hopping sequence is determined by the Bluetooth clock of the master system. For this reason, the slave maintains the clock offset fields in order to hop in accordance with the master's clock.

The AM_ADDR field represented in Table 1 is an active member address field containing the active slave's particular address within the piconet. It is used to distinguish among the active members of a piconet. For instance, a piconet that is capable of containing up to seven active slaves must provide for a unique piconet address for each of the active slaves. Table 1 illustrates that, in at least one embodiment, the AM_ADDR field is three bits long because three bits are needed to generate a binary representation of the number 7 (i.e., 1b‘111’).

The FHS_misc field represented in Table 1 is a field containing the following sub-fields: scan repetition, scan period, and page scan mode. These fields relate to time periods, intervals, and mode for the paging procedure by which connections are established in Bluetooth piconets. A master device sends out a page message to a slave device with which the master is attempting to establish a connection. A slave that is not already connected periodically wakes up in a page scan state and looks for pages that may have been sent to it. In the page scan state, the slave scans for, and receives, page messages. When a page message is successfully received by the slave, there is a synchronization between the master and the slave, thereby establishing a connection between the master and the slave.

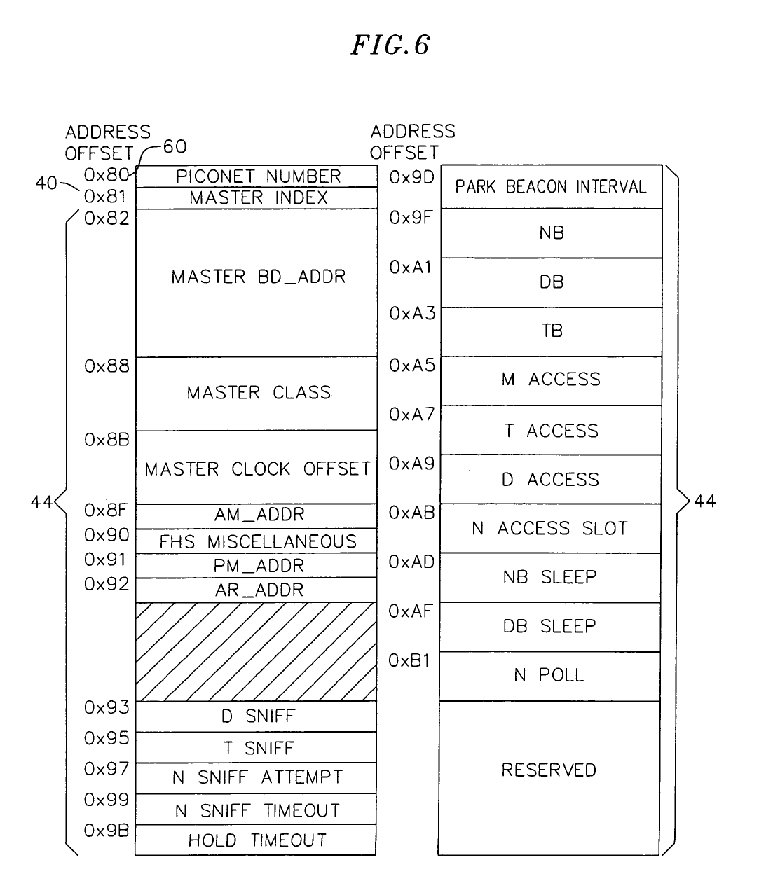

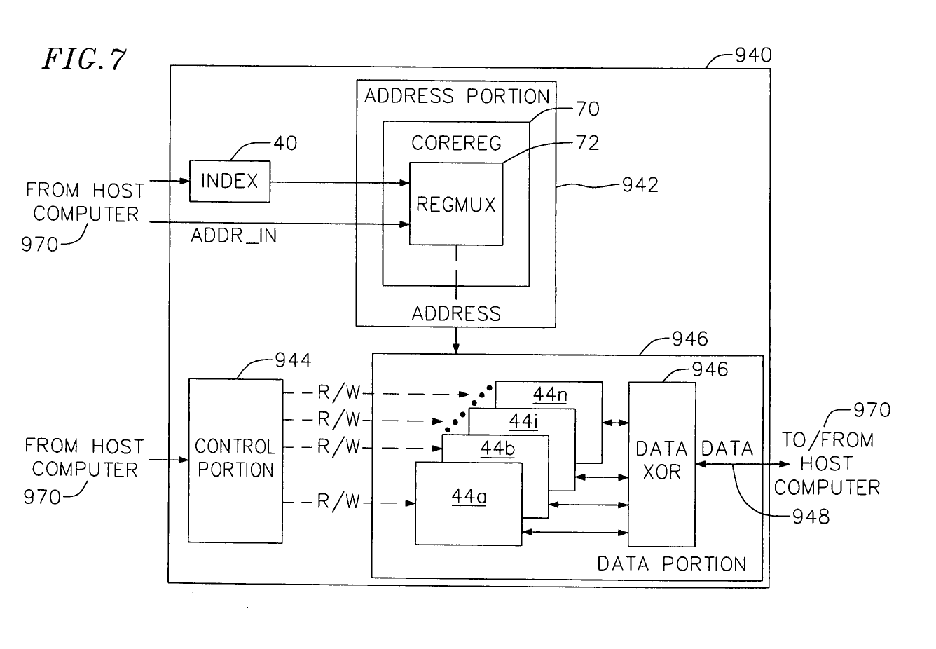

FIG. 6 and Table 2, below, set forth an exemplary format of the information stored in each master register 44. One skilled in the art will recognize that the format of the master registers 44 will depend on specific design considerations. In general, the master registers 44 contain any context information and parameters necessary to allow the slave system 102-2-102-n (FIG. 2) to quickly switch contexts among master systems. The format and the addresses of the information set forth in FIG. 6 and Table 2 should be taken to be an exemplary format and address scheme only. One skilled in the art will recognize that the fields may be stored in any order, at any register location.

TABLE 2

| | | | readable/ | bit | connection | | # of | |
|---|---|---|---|---|---|---|---|---|
| address | Name | reset | writable | location | field | description | bits | default |
| 0x82 | NAP_hi | s | R/W | [7:0] | NAP[15:8] | 0x82 | 8 | x00 |
| | NAP-lo | s | R/W | [7:0] | NAP [7:0] | 0x83 | 8 | x00 |
| | UAP | s | R/W | [7:0] | UAP[7:0] | 0x84 | 8 | x00 |
| | LAP_hi | s | R/W | [7:0] | LAP[23:16] | 0x85 | 8 | x00 |
| | LAP_md | s | R/W | [7:0] | LAP[15:8] | 0x86 | 8 | x00 |
| | LAP_lo | s | R/W | [7:0] | LAP[7:0] | 0x87 | 8 | x00 |
| 0x88 | Class_hi | s | R/W | [7:0] | class[23:16] | 0x88 | 8 | x00 |
| | Class_md | s | R/W | [7:0] | class[15:8] | 0x89 | 8 | x00 |
| | Class_lo | s | R/W | [7:0] | class[7:0] | 0x8a | 8 | x00 |
| 0x8B | clock offset | s | R/W | [7:0] | clock[27:24] | 0x8b | 8 | x00 |
| | upper | | | | | | | |
| | clock offset | s | R/W | [7:0] | clock[23:16] | 0x8c | 8 | x00 |
| | hi | | | | | | | |
| | clock offset | s | R/W | [7:0] | clock[15:8] | 0x8d | 8 | x00 |
| | md | | | | | | | |
| | clock offset | s | R/W | [7:6] | clock[7:0] | 0x8e | 2 | 0 |
| | lo | | | | | | | |
| 0x8F | AM_ADDR | s | R/W | [2:0] | AM_ADDR | 0x8f | 3 | 0 |
| 0x90 | FHS_misc | s | R/W | [7:6] | Scan | 0x90 | 2 | 0 |
| | | | | | Repetition | | | |
| | | | R/W | [5:4] | Scan Period | | 2 | 0 |
| | | | R/W | [3:1] | Page Scan | | 3 | 0 |
| | | | | | Mode | | | |
| 0x91 | PM_ADDR | s | R/W | [2:0] | assigned | 0x91 | 8 | 0 |
| | | | | | PM_ADDR | | | |
| | | | | | by master | | | |
| 0x92 | AR_ADDR | s | R/W | [2:0] | assigned | 0x92 | 8 | 0 |
| | | | | | AR_ADDR | | | |
| | | | | | By master | | | |
| 0x93 | Dsniff_hi | s | R/W | [7:0] | connection | 0x93 | 8 | x00 |
| | | | | | specific Dsniff | | | |
| | Dsniff_lo | s | R/W | [7:0] | | 0x94 | 8 | x00 |
| 0x95 | Tsniff_hi | s | R/W | [7:0] | Tsniff | 0x95 | 8 | x00 |
| | Tsniff_lo | s | R/W | [7:0] | | 0x96 | 8 | x00 |
| 0x97 | N sniff | s | R/W | [7:0] | N sniff | 0x97 | 8 | x00 |
| | attempt hi | | | | attempt | | | |
| | N sniff | s | R/W | [7:0] | | 0x98 | 8 | x00 |
| | attempt lo | | | | | | | |
| 0x99 | N sniff | s | R/W | [7:0] | N sniff | 0x99 | 8 | x00 |
| | timeout hi | | | | timeout | | | |
| | N sniff | s | R/W | [7:0] | | 0x9a | 8 | x00 |
| | timeout lo | | | | | | | |
| 0x9B | holdTO_hi | s | R/W | [7:0] | holdTO | 0x9b | 8 | x00 |
| | holdTO_lo | s | R/W | [7:0] | | 0x9c | 8 | x00 |
| 0x9D | Tbeacon_hi | s | R/W | [7:0] | Park Beacon | 0x9d | 8 | x00 |
| | | | | | interval | | | |
| | Tbeacon_lo | s | R/W | [7:0] | | 0x9e | 8 | x00 |
| 0x9F | NB_hi | s | R/W | [7:0] | NB | 0x9f | 8 | x00 |
| | NB_lo | s | R/W | [7:0] | | 0xa0 | 8 | x00 |
| 0xA1 | DB_hi | s | R/W | [7:0] | DB | 0xa1 | 8 | x00 |
| | DB_lo | s | R/W | [7:0] | | 0xa2 | 8 | x00 |
| 0xA3 | TB_hi | s | R/W | [7:0] | TB | 0xa3 | 8 | x00 |
| | TB_lo | s | R/W | [7:0] | | 0xa4 | 8 | x00 |
| 0xA5 | Maccess_hi | s | R/W | [7:0] | Maccess | 0xa5 | 8 | x00 |
| | Maccess_lo | s | R/W | [7:0] | | 0xa6 | 8 | x00 |
| 0xA7 | Taccess_hi | s | R/W | [7:0] | Taccess | 0xa7 | 8 | x00 |
| | Taccess_lo | s | R/W | [7:0] | | 0xa8 | 8 | x00 |
| 0xA9 | Daccess_hi | s | R/W | [7:0] | Daccess | 0xa9 | 8 | x00 |
| | Daccess_lo | s | R/W | [7:0] | | 0xaa | 8 | x00 |
| 0xAB | Nacc_slot | s | R/W | [7:0] | Nacc_slot | 0xab | 8 | x00 |
| | hi | | | | | | | |
| | Nacc_slot | s | R/W | [7:0] | | 0xac | 8 | x00 |
| | lo | | | | | | | |
| 0xAD | NB_sleep | s | R/W | [7:0] | NB_sleep | 0xad | 8 | x00 |
| | hi | | | | | | | |
| | NB_sleep | s | R/W | [7:0] | | 0xae | 8 | x00 |
| | lo | | | | | | | |
| 0xAF | DB_sleep | s | R/W | [7:0] | DB_sleep | 0xaf | 8 | x00 |
| | hi | | | | | | | |
| | DB_sleep | s | R/W | [7:0] | | 0xb0 | 8 | x00 |
| | lo | | | | | | | |
| 0xB1 | Npoll hi | s | R/W | [7:0] | Npoll | 0xb1 | 8 | x00 |
| | Npoll lo | s | R/W | [7:0] | | 0xb2 | 8 | x00 |

The NAP (Non-significant Address Part), UAP (Upper Address Part), and LAP (Lower Address Part) fields reflected in Table 2 together comprise the BD address for the master system being tracked in the particular register 44. The BD address is, in at least one embodiment, 48 bits long.

The class fields (Class_hi, Class_md, Class_lo) reflected in Table 2 refer to the particular class of Bluetooth master system being tracked in the particular register 44.

The master clock offset fields (clock offset upper, clock offset hi, clock offset md, clock offset lo) reflected in Table 2 represent a delta value between the slave's clock and the master's clock. The master can take this value into account when communicating with a slave in order to plan for a more efficient transmission.

The AM_ADDR field represented in Table 2 is an active member address field containing the master's particular address within the piconet. It is used by the slave when addressing communication packets to the master. The AM_ADDR field in the master register 44 is a 3-bit field as explained above in connection with Table 1.

The FHS_misc field represented in Table 2 is a field containing the following sub-fields: scan repetition, scan period, and page scan mode, as is explained above in connection with Table 1.

The PM_ADDR and AR-ADDR fields relate the park mode. That is, even when a slave is parked, the slave maintains master context data in its master registers 44. When a slave device transitions from a park mode to a slave mode, the slave gives up its AM_ADDR active member address value. Instead, the parked slave receives two new addresses, assigned by the master, to be used in the park mode: PM_ADDR (parked member address) and AR_ADDR (access request address). PM_ADDR distinguishes a parked slave from other parked slaves. In tracking context data for one or more masters, the parked slave keeps track of its PM_ADDR for each master—the PM_ADDR is used by the master in a master-initiated unpark procedure. The AR-ADDR is a master-assigned address to be used by the slave in a slave-initiated unpark procedure.

The next several fields depicted in Table 2 relate to a “sniff” mode. These fields include the Dsniff fields (Dsniff_hi, Dsniff_lo), the Tsniff fields (Tsniff_hi, Tsniff_lo), the Nsniff attempt fields (Nsniff attempt hi, Nsniff attempt lo), and the Nsniff timeout fields (N sniff timeout hi, N sniff timeout 1). In the sniff mode, the duty cycle of an active slave's listen activity is reduced because the time slots in which the master can start transmission to a specific slave are reduced to specified time slots. Therefore, when an active slave is in sniff mode, it need only listen during its assigned sniff slots. These so-called sniff slots are spaced regularly within an interval of T_{sniff}. The slave must listen at the D_{sniff} slot every sniff period, T_{sniff}, for an N_{sniff} attempt number of times. If the slave receives a packet during its sniff period, it should continue listening as long as it continues to receive packets. Once the slave stops receiving packets, it should continue listening for N_{sniff timeout} more slots or the remaining of the N_{sniff attempt} number of slots, whichever is greater.

The hold timeout fields (holdTO_hi, holdTO_lo) relate to a hold mode. A slave can be put into a hold mode wherein the slave is still active but its communication abilities on the channel are temporarily limited. During the hold mode, the slave keeps its active member address (AM_ADDR). Before the slave enters the hold mode, the slave and master agree on the time duration that the slave is to remain in the hold mode. This time value is stored in the hold timeout fields.

The remaining fields represented in Table 2 relate to the beacon channel. To support parked slaves, the master establishes a beacon channel when one or more slaves are parked. The beacon channel is used for the transmission from the master to the parked slave of information that the slave can use for re-synchronization. The beacon channel is also used to carry messages to the parked slaves to change the beacon parameters and to carry general broadcast messages to the parked slaves. Finally, the beacon channel is used for the unparking of one or more parked slaves.

FIG. 9 illustrates the organization of at least one embodiment of a Bluetooth system 900, which is relevant to the following discussion. FIG. 9 illustrates that a Bluetooth system 900, such as a cell phone or a PDA, consists of a host computer 970 and a peripheral system 972. The peripheral system 972 includes an analog component and a digital component. The analog component is a radio unit 910. For additional details concerning at least one aspect of at least one embodiment of the radio unit 910, please refer to U.S. Pat. No. 6,560,449, which is herein incorporated by reference in its entirety for all purposes. For additional details concerning the operation of at least one aspect of at least one other embodiment of the radio unit 9.10, please refer to U.S. Pat. No. 6,778,594, which is herein incorporated by reference in its entirety for all purposes.

The digital component of the peripheral system 972 is the host controller 930. A computing device such as those 102-1, 102-2 through 102-n depicted in FIGS. 1 and 2 need not necessarily contain all of the elements depicted in FIG. 9 in order to practice the present invention.

The host controller 930 includes hardware components (circuitry) 920, 940, 950 and software components 960, 980. The external interface 950 performs link management and provides interface functions with a host computer 970. The host 970 communicates with the host controller 930 via the software of the host interface 980 as it operates on the external interface hardware 950. The host 970 receives asynchronous event notifications when a significant event has occurred. The host 970 parses the notification to determine what event has occurred. A more detailed discussion of the host interface 980 can be found at Part H:1, “Host Controller Interface Functional Specification” of ver. 1.0b of the Bluetooth Specification, which is hereby incorporated by reference or all purposes.

The link controller 920 performs Bluetooth baseband processing and handles physical layer protocols. The Link Manager software 960 discovers other remote link manager programs and utilizes the services of the link controller 920 to communicate with them.

FIG. 9 illustrates that the Link Manager software 960 runs on the state machine 940. The state machine 940 provides hardware circuits that provide access to the register architecture discussed above in connection with FIG. 4.

FIGS. 7, 8 and 9 illustrate that the state machine 940 includes a control portion 944, a data portion 946, and an address portion 942. The data portion of the state machine 940 includes the master registers 44a-44n, the master index register 40, the slave registers 46a-46m, and the slave index register 42. The address portion 942 of the state machine 940 includes circuits referred to as the Corereg circuit 70 and the Regmux circuit 72.

FIG. 7 is a block diagram depicting the use of the master index to perform context-switching for a slave device. FIG. 7 illustrates that the contents of the master index register 40 are used to select which of the master registers 44 the slave wishes to access. For instance, if the slave wishes to access a first master register 44a, then a value of 1b‘00000000’ is loaded by the host 970 into the master index register 40. For each of the remaining master registers 44b-44n, a corresponding index value is loaded into the master index register 40 when the slave needs to retrieve context data stored in that particular master register 44b-44n. Once the master index register 40 is loaded with the appropriate value, then the Corereg circuit 70 and Regmux circuit 72 perform logic, described below, to read from, or write to, the master register 44 of interest. A context switch, when a slave desires to switch contexts among masters, is thus performed simply by the host computer's 970 changing of the value in the master index register 40.

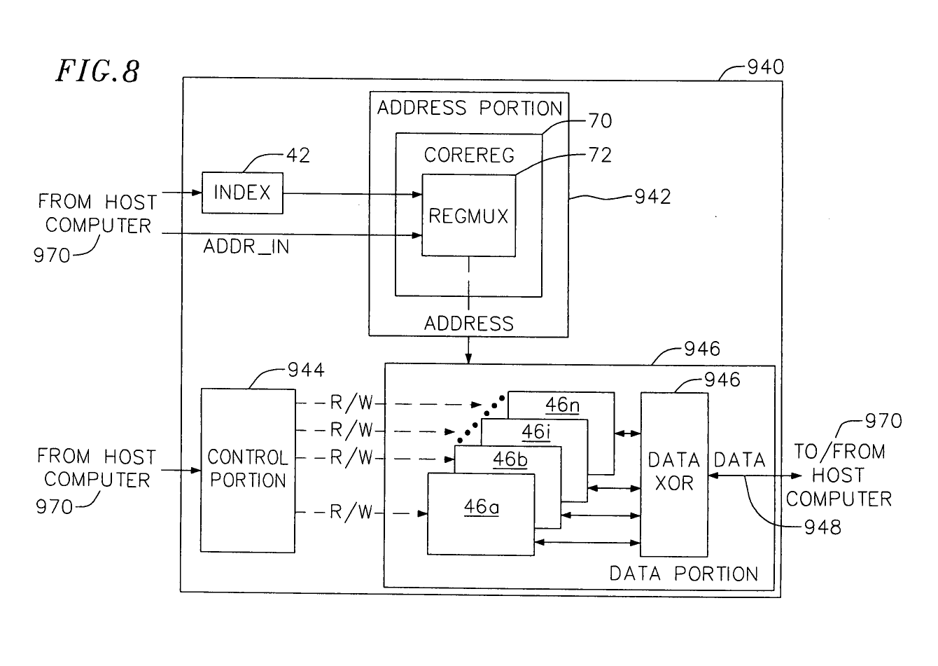

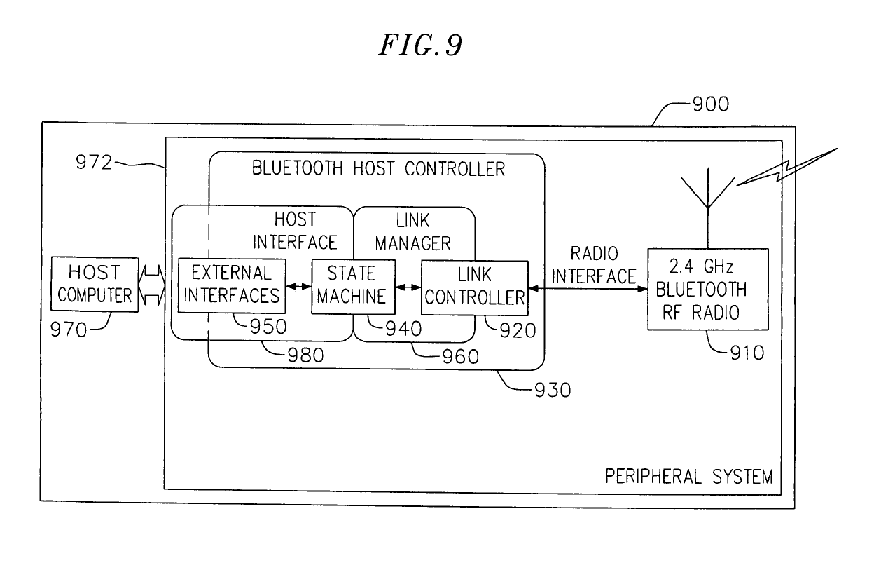

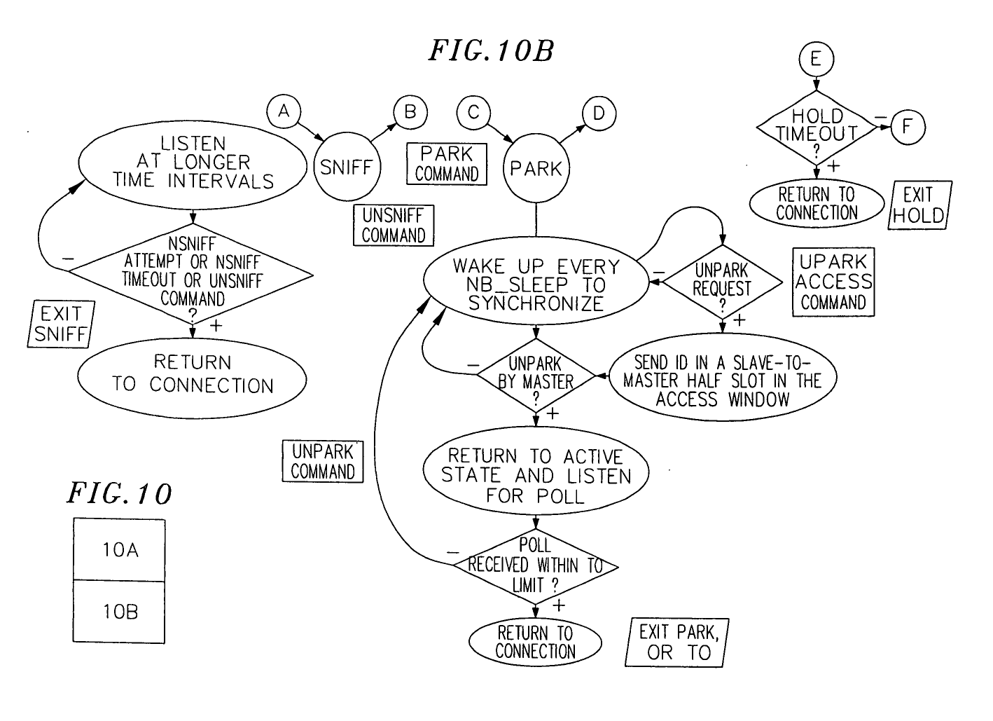

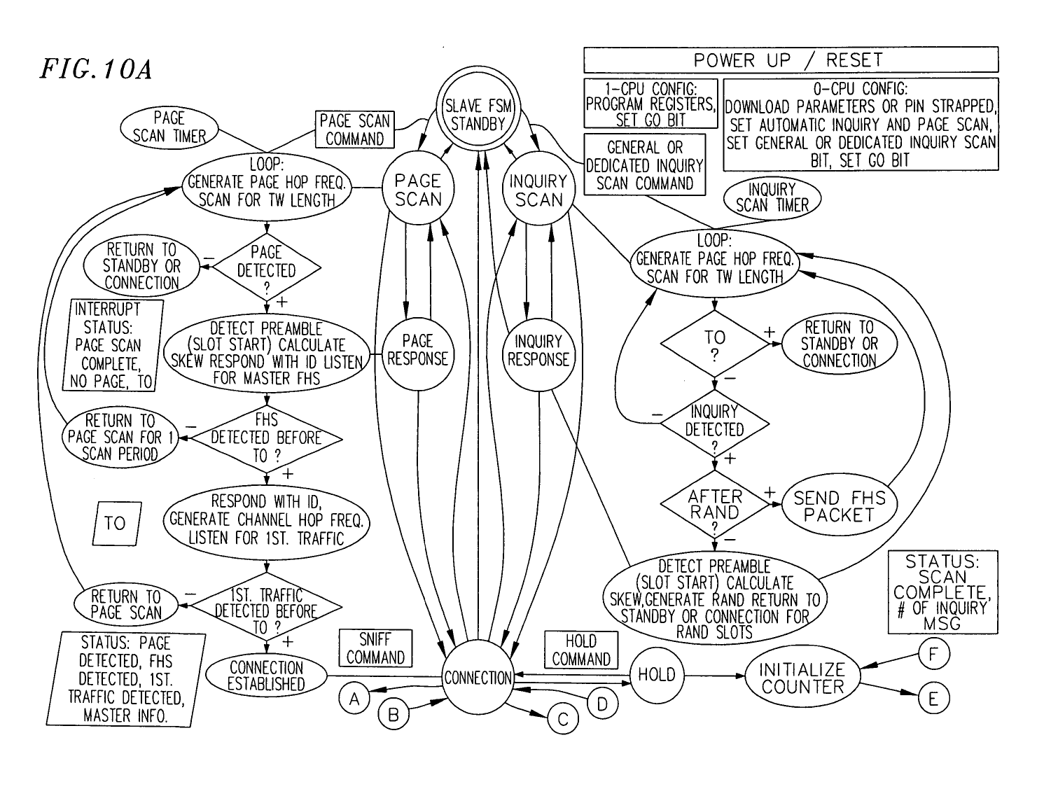

FIG. 8 is a block diagram depicting the use of the slave index to perform context-switching for a master device. FIG. 8 illustrates that the contents of the slave index register 42 are used to select which of the slave registers 46 the master wishes to access. For instance, if the master wishes to access a third slave register 46c, then a value of 1b‘00000011’ is loaded into the slave index register 42. For each of the remaining slave registers, a corresponding index value is loaded into the slave index register 42 when the master wishes to retrieve context data stored in that particular slave register.

FIGS. 8 and 9 illustrate that, once the host computer 970 loads the slave index register 42 with the appropriate value, then the Corereg circuit 70 and Regmux circuit 72 perform logic, described below, to read from, or write to, the slave register 46 of interest. A context switch, when a master desires to switch contexts among slaves, is thus performed simply by the host computer's 970 changing of the value in the slave index register 42 so that the Corereg 70 and Regmux 72 circuits can operate to retrieve and/or modify the specified contents of the slave register 46 of interest.

The discussion above illustrates that a master system having a slave index 42 and one or more slave registers 46 can quickly perform context-switching among slaves. Similarly, FIG. 7 illustrates that a slave system having a master index 40 and one or more master registers 44 can quickly perform context-switching among masters. Because the information described above in Table 1 is stored in the slave registers 46, and the information described above in Table 2 is stored in the master registers 44, the context information need not be stored in software data structures nor stored on the microprocessor of the host computer 970. This allows the context data to be accessed more quickly than if it were transferred from memory to registers upon a context switch.

While software running on the host computer 970 does not need to store the context information, it still needs to be able to identify and access the particular context data for the incoming slave that a master is interested in switching to, and must be able to identify and access the particular context data for the incoming master that a slave is interested in switching to. This function of identifying and accessing the context information for the incoming slave or master is accomplished through the use of a slave index 42 and master index 40, respectively. In at least one embodiment, the slave index 42 is located at register memory location 0xC0 and the master index 40 is located at register memory location 0x81.

It is significant to note, as the preceding discussion illustrates, that the present context-switch registers 40, 42, 44a-44n, 46a-46m are provided in the peripheral system 972 rather than in the host computer 970 of a computing device 900. With such a scheme, there is no need for the context information to be transferred from the host computer 970 to the peripheral system 972. This is in direct contrast to, and provides many advantages over, systems that retain context data in the host system. One such system is disclosed in U.S. Pat. No. 5,926,646, entitled “Context-Dependent Memory-Mapped Registers for Transparent Expansion of Register File,” and issued to Pickett et al. (hereinafter referred to as “Pickett '646”). Pickett '646 provides within a microprocessor an expanded set of registers in addition to the architected set of registers. In contrast to the Pickett '646 approach, the present architecture does not require that the context information be moved from registers (architected or otherwise) in the host computer 970 to the peripheral system 972 each time a context switch occurs. Such transfer slows down the context-switch operation and burdens the network with transmission of context information. The present architecture therefore provides for versatility in network systems by permitting the use of slower, lower performance host computers 970 while still supporting relatively fast context switches.

FIG. 7, FIG. 8, and FIG. 9 illustrate that the Corereg circuit 700 is a logic circuit included in the address portion 942 of the state machine 940. The Corereg circuit 700 performs logic to access the desired location within a master register 44 or slave register 46. At least one embodiment of the Corereg register access circuit 70 may be implemented, for example, by Verilog source code listed in Appendix A.

The Corereg register access circuit 70 receives various input values that are provided by software running on the host system 970. One such input value is an Addr_in value, which represents the particular address of the desired field within the master register 44 or slave register 46 of interest. Another input value is the index value in either the master index register 40 or the slave index register 42. For purposes of illustration, reference is made to FIGS. 3 and 7 and Tables 1 and 2. For instance, a slave system 32 may switch contexts from a first master 102-1 (whose context information is tracked, say, in master register 44a) to a second master 36 (whose context information is tracked, say, in master register 44b). In at least one embodiment, an index value of 4b‘0000’ represents the first master register 44a while an index value of 4b‘0001’ represents the second master register 44b. In order to switch the contexts, then, the link controller 920 (FIG. 9) replaces the index value of 4b‘000’ with an index value of 4b‘0001’ in the master index register 40. In this manner, a context switch has occurred.

The Addr_in input address is the address of the particular field within a slave register 46 or master register 44. For instance, Table 1 indicates that the link controller 920 (FIG. 9) would set Addr_in to a value of 4b‘0xCE’ if a master needed to read or modify the AM_ADDR field for a particular active slave.

FIG. 7 and FIG. 8 illustrate that the Corereg module 70 includes logic provided by the Regmux 72 circuit. In at least one embodiment, the Regmux circuit 72 is a circuit defined by the Verilog source code listed in Appendix B and is a mux circuit that, given the proper index value and Addr_in value, returns the specific register location of interest.

One skilled in the art will recognize that logic performed by the Corereg 70 and Regmux 72 circuits may be performed by hardware modules, or may be implemented as software modules, firmware modules, or any combination thereof. One skilled in the art will further recognize, that such processing may be implemented as a single hardware or software module that includes various logical functions, rather than separate modules. If implemented in software modules, the software can be executed, for instance, by an embedded CPU that is used instead of the state machine 940.

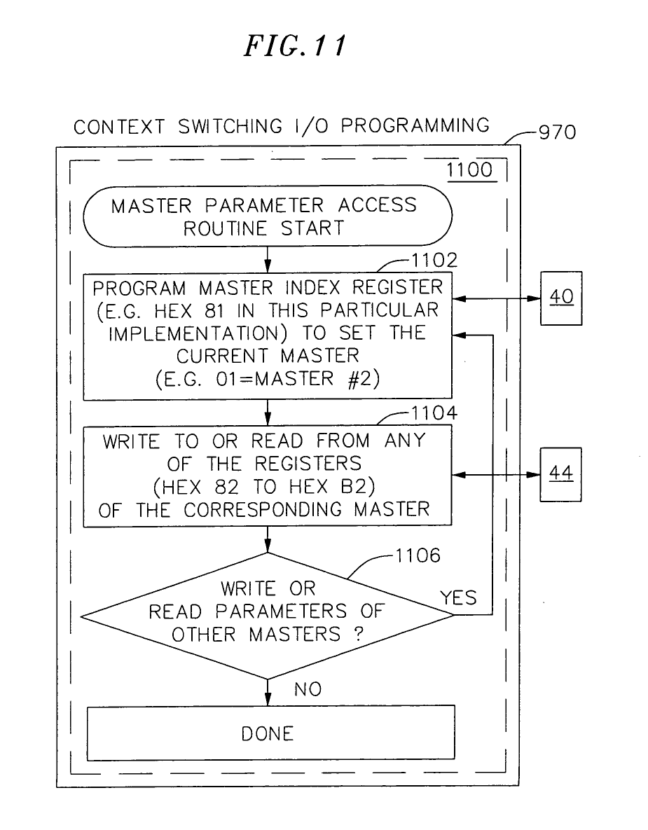

FIG. 11 is a flowchart illustrating a master parameter access software module 1100 that invokes the logic of the state machine 940 to access information in a master register 44. The master parameter access module 1100 contains machine-executable instructions that are executed, for example, on the host computer 970.

FIG. 11 illustrates that the host 970, when executing operation 1102, loads the appropriate index value into the master index register 40. For instance, if the master register of interest 44 is a second master register (where the index value for a first master register is zero), then a value of 4b‘01’ is loaded by the host 970 into the master index register 40 in operation 1102. The host computer 970 then executes operation 1104. Operation 1104 invokes the Corereg logic circuit 70 (FIG. 7) to write or read from the register of interest 44. Operation 1104 includes a read path and a write path.

FIGS. 9 and 11 illustrate that, during the read path of operation 1104, the host computer 970 provides the following inputs and then invokes the Corereg logic circuit 70:
provide the Addr_in address value that identifies the address of field of interest within the register of interest, and
provide a read control input, which is a read strobe indicating that the contents of the indicated register field should be put onto the data lines 948.

During the write path of operation 1104, the host computer 970 provides the following inputs and then invokes the logic of the Corereg logic circuit 70:
provide the Addr_in address value that identifies the address of field of interest within the register of interest,
provide a data value to be written to the indicated register field, and
provide a write control input, which is a write strobe indicating that the data value should be written to the contents of the indicated register field.

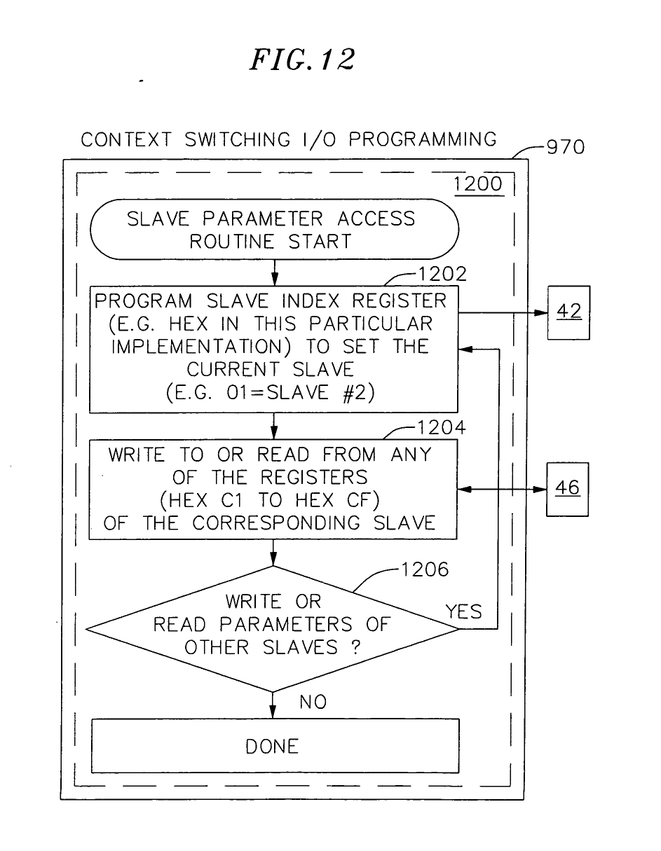

FIG. 12 is a flowchart illustrating a slave parameter access software module 1200 that invokes the logic of the state machine 940 to access information in a slave register 46. The slave parameter access module 1200 contains machine-executable instructions that are executed, for example, on the host computer 970.

FIG. 12 illustrates that the host computer 970, when executing operation 1202, loads the appropriate index value into the slave index register 42. For instance, if the slave register of interest 46 is a second slave register (where the index value for a first slave register is zero), then a value of 4b‘01’ is loaded by the host 970 into the slave index register 42 in operation 1202. The host computer 970 then executes operation 1204. Operation 1204 invokes the Corereg logic circuit 70 (FIG. 7) to write or read from the register of interest 46. Operation 1204 includes a read path and a write path.

FIGS. 9 and 12 illustrate that, during the read path of operation 1204, the host computer 970 provides the following inputs and then invokes the Corereg logic circuit 70:
provide the Addr_in address value that identifies the address of field of interest within the register of interest, and
provide a read control input, which is a read strobe indicating that the contents of the indicated register field should be put onto the data lines 948.

During the write path of operation 1204, the host computer 970 provides the following inputs and then invokes the logic of the Corereg logic circuit 70:
provide the Addr_in address value that identifies the address of field of interest within the register of interest,
provide a data value to be written to the indicated register field, and
provide a write control input, which is a write strobe indicating that the data value should be written to the contents of the indicated register field.

One skilled in the art will recognize that, although the master parameter access module 1100 and the slave parameter access module 1200 have been described as a series of sequential operations, the operations need not necessarily be performed in the order discussed. Instead, the operations may be performed in any order that preserves the functionality described herein. For instance, the respective inputs of the read and write paths may be provided in any order in operations 1104 and 1204. One skilled in the art will further recognize that operations that have been shown as separate operations may be performed in the same logical group on instructions.

The computer-readable instructions included in the present invention can be implemented as software instructions on a computer-readable tangible medium such as any magnetic storage medium, including disk and tape storage medium; an optical storage medium, including compact disk memory and a digital video disk storage medium; a nonvolatile memory storage memory; a volatile storage medium; or data transmission medium including packets of electronic data and electromagnetic waves modulated in accordance with the instructions.

Although the invention has been described with reference to particular embodiments, the description is only an example of the invention's application and should not be taken as a limitation. For example, although the above disclosure refers to the Bluetooth specification, the context-switching architecture disclosed herein may be used in any network environment where context-switching among computing devices is performed. For example, the present invention may be employed in any network, such as a client/server network, and need not necessarily be employed in a master/slave network environment. Similarly, the registers described herein need not contain master and slave data, but can rather contain any context data. Various other adaptations and combinations of features of the embodiments disclosed are within the scope of the invention as defined by the following claims.

What is claimed is:

1. A method of switching contexts in a wireless communication system, comprising:
storing master or slave context data associated with a plurality of wireless communication devices in a at least one register;
associating index values with the master or slave context data associated with each wireless communication device;
using a first one of the index values to access, in the at least one register, master or slave context data associated with a first one of the wireless communication devices;
communicating with the first one of the wireless communication devices in accordance with the master or slave context data associated with the first one of the wireless communication devices;
using a second one of the index values to access, in the at least one register, master or slave context data associated with a second one of the wireless communication devices; and
communicating with the second one of the wireless communication devices in accordance with the master or slave context data associated with the second one of the wireless communication devices.

2. The method of claim 1 wherein the first one and the second one of the wireless communication devices comprise network master devices in a Bluetooth-based network.

3. The method of claim 1 wherein the first one and the second one of the wireless communication devices comprise network slave devices in a Bluetooth-based network.

4. The method of claim 1 wherein the at least one register comprises at least one non-architected register.

5. The method of claim 1 wherein:
the at least one register is implemented in a host controller that is adapted to establish communications in a Bluetooth network; and
a host computer sends the index values to the host controller to access the master or slave context data stored in the at least one register.

6. The method of claim 1 wherein the first one and the second one of the wireless communication devices comprise network master devices in a Bluetooth-based network, the method further comprising:
using a third one of the index values to access, in the at least one register, slave context data associated with a third one of the wireless communication devices;
communicating with the third one of the wireless communication devices in accordance with the slave context data associated with the third one of the wireless communication devices;
using a fourth one of the index values to access, in the at least one register, slave context data associated with a fourth one of the wireless communication devices; and
communicating with the fourth one of the wireless communication devices in accordance with the slave context data associated with the fourth one of the wireless communication devices.
